(19) United States
(12) Patent Application Publication
(10) Pub. No.: US 2024/0357950 A1
(43) Pub. Date: Oct. 31, 2024

(54) Agricultural Implement Utilizing Multi-functional Wheel Providing Depth Gauging, Seed Trench Closing, and Trencher Disc Cleaning Functions

(71) Applicant: Matthew Hornung, Dodge City, KS (US)

(72) Inventor: Matthew Hornung, Dodge City, KS (US)

(21) Appl. No.: 18/307,370

(22) Filed: Apr. 26, 2023

(51) Int. Cl. A01B 21/08; A01B 63/24

(52) U.S. Cl. CPC A01B 21/086; A01B 63/24

(57) ABSTRACT

An agricultural planter with seed trencher discs and seed delivery mechanism is disclosed which deposits seeds or product in the trench opened by the discs. Multi-functional wheels are mounted rearward of the trencher discs on an adjustable arm so as to provide a depth gauging function for the trencher discs. The wheels are mounted to run at an angle and distance corresponding to the disc blades so as to movably scrape clean dirt and debris from the disc blades opening the trench. The wheels are positioned to move displaced trench soil back over the trench while effectively running at a position where dirt and debris try to lift out of the opening trench due to the action of the disc cutting blades.

### BACKGROUND

Planting equipment has long been used for planting seeds such as row and cereal crops. Typically planting seeds is accomplished by means of a row crop planter and a grain drill or air seeder. The forgoing will briefly describe typical arrangements of each.

A row crop planter commonly refers to seeders with the capability of singulating seeds for each opener unit's placement, and typically with a relatively wide spacing between individual opener units. A typically row crop planter opener unit includes one or more seed singulating devices and opening discs for creating a V-shaped slot in the soil for seed placement. Gauge wheels running along the side of the opening discs on the planter determine the maximum planting depth and scrap the outside surface of the discs to keep wet soil from building up on the disc. Separate closing wheels behind the opening disks are responsible for closing the V-shaped slot in the soil after the seeds have been placed therein.

A grain drill or air seeder commonly refers to a seeder lacking the capability of equally spaced seed singulation and seeds at higher rates than that of a row crop planter. In a grain drill configuration, seed is volumetrically metered from a hopper box above the furrow opener utilizing gravity to deliver the seed to the seed trench. Alternatively, a grain drill air seeder refers to a centralized hopper that volumetrically meters seed and then utilizes a fan to blow seed out to each opener unit and into the trench.

Grain drills and air seeders tend to have the opener units mounted to achieve narrow row spacing, although the openers may be mounted in a staggered pattern of two or more ranks on a single or multiple toolbars. Drill or seeder opener units are manufactured employing a wide variety of furrow openers, including non-rolling shank style openers, and both single-and double-disc openers. These openers typically gauge their depth and close the seed trench from packer or press wheels that operate rearward of the shank or disc blades. Separate disc scrapers are mounted to the opener for removing wet or tight soil from the disc blades and improving soil trench cutting and forming.

Some disc-openers also gauge their depth by using a gauge wheel alongside the opener and separate wheel or wheels for closing the seed trench. One issue with this style of opener is adequate clearance to the adjacent row to allow high residue and straw to move through the system in a narrow spacing drill configuration. Narrow spacing with this type of opener is accomplished by staggering the openers or mounting on two different ranks to allow material to flow through. With this type of configuration turning and contouring with the openers in the ground is greatly restricted due to the overlapping of the adjacent forward row from the reward row. Additionally side load and wear is greatly increased due to this staggered double rank configuration.

### BRIEF DESCRIPTION OF THE DRAWINGS

FIG. 1 depicts a side perspective view of an example multi-functional wheel trenching device.

FIG. 2 depicts a front perspective view of the example multi-functional wheel trenching device.

FIG. 3 depicts a rear perspective view of the example multi-functional wheel trenching device.

FIG. 4 depicts a bottom perspective view of the example multi-functional wheel trenching device.

FIG. 5 depicts a perspective view of the example multi-functional wheel trenching device.

FIG. 6 depicts a perspective view of an example single multi-purpose wheel device with in-row firming wheel.

FIG. 7 depicts a side perspective view of the example single multi-purpose wheel device with in row firming wheel.

FIG. 8 depicts an additional side perspective view of an example single multi-purpose wheel device with in row firming wheel.

FIG. 9 depicts a functional side perspective view of an example single multi-purpose wheel device.

FIG. 10 depicts a bottom perspective view of the example multi-purpose wheel device, displaying wheel rotations.

FIG. 11 depicts a wheel of the example multi-purpose wheel device displaying curved and cupped fingers of the wheel.

FIG. 12 depicts a top perspective view of two example single multi-purpose wheel devices, working in tandem.

FIG. 13 depicts a perspective view of two example single multi-purpose wheel devices, working in tandem.

FIG. 14 shows an example of camber adjustment relative to the central plane.

FIG. 15 and FIG. 16 illustrate an in-row firming wheel that is spring/torsion loaded and runs in the bottom of the seed trench created by the trench opener disc.

### DETAILED DESCRIPTION

An agricultural implement is disclosed as it may utilize a multi-functional wheel or wheels that provide a row unit depth gauging function, seed trench closing function, and trencher disc cleaning function.

In an example, an agricultural planter with seed trencher discs and seed delivery mechanism deposits seeds (or other product) in the trench opened by the discs. Multi-functional wheels are mounted rearward of the trencher discs on an adjustable arm so as to provide a depth gauging function for the trencher discs. The wheels are mounted to run at an angle and distance corresponding to the disc blades, so as to movably scrape clean dirt and debris from the disc blades opening the trench. The wheels are positioned to move displaced trench soil back over the trench while effectively running at a position where dirt and debris try to lift out of the opening trench due to the action of the disc cutting blades. This allows the wheels to apply pressure in the lift out zone area of dirt and debris as to prevent the lift out from occurring. The wheels have optional fingers arrayed around the wheel rim to further prevent soil lift out and aid in movement of crop debris and residue through the system while reducing the soil to a fine homogenous soil for an optimal planting condition. Furthermore, this multi-functional wheel configuration allows for narrow spacing of adjacent seeder devices while keeping crop debris residue from building up between devices and plugging.

In an example, a multi-functional wheel trenching device includes a trench opener disc. The multi-functional wheel trenching device includes a multi-functional wheel, coupled to the trench opener disc. In an example, the multi-functional wheel comprises one or more gauging functions for the trench opener disc. The multi-functional wheel trenching device further includes a trench closing function. The multi-functional wheel trenching device includes a cleaner function to scrape dirt and residue from the trench opener disc.

In an example, an array of fingers are each of a short length relative to the radius of the multi-functional wheel,

In an example, each of the array of fingers is configured to extend forward of the wheel outer rim as the wheel rolls through a lower forward quadrant, and extend outward of the plane of the wheel.

In an example, an array of teeth can be positioned around an outer rim or circumference of the multi-functional wheel.

In an example, each of the array of teeth extend inwardly of the plane of the wheel.

In an example, each of the array of teeth are configured to scrape dirt from the trench opener disc.

In an example, each of the array of fingers are curved, and cupped.

In an example, the trench opener disc is configured to rotate the array of fingers to move soil into a trench.

In an example, the multi-functional wheel is configured to adjust in a vertical direction, resulting in a gauge of a seeder planting depth.

In an example, the multi-functional wheel is adjustable in a horizontal direction via a horizontal chamber relative to the central plane of the multi-functional wheel, resulting in an increase or decrease of soil over a seed trench.

In an example, the multi-functional wheel is adjustable in a vertical direction and in a pitch angle relative to the central plane of the multi-functional wheel, resulting in an increase or decrease of a movement of soil.

In an example, the trench opener disc is configured to be adjustable in pitch and camber relative to the central plane of the trench opener disc.

In an example, the multi-functional wheel is configured with a reverse horizontal chamber and vertical pitch of the trench disc opener.

In an example, a seed trench closing wheel can include an array of fingers comprising a short length relative to the radius of the wheel. The array of fingers is configured to extend forward of an outer rim of the wheel as the wheel rolls through a lower forward quadrant. The array of fingers is configured to extend outward from the plant of the wheel. The array of fingers is configured to curve and cup, resulting in the array of fingers scooping and moving the soil covering a seed trench.

In an example, each of the array of fingers is configured to extend inwardly of a plane of the wheel, resulting in the soil moving continuously in an outward direction of the wheel, to inwardly fill the seed trench.

Before continuing, it is noted that as used herein, the terms “includes” and “including” mean, but is not limited to, “includes” or “including” and “includes at least” or “including at least.” The term “based on” means “based on” and “based at least in part on.”

It should also be noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

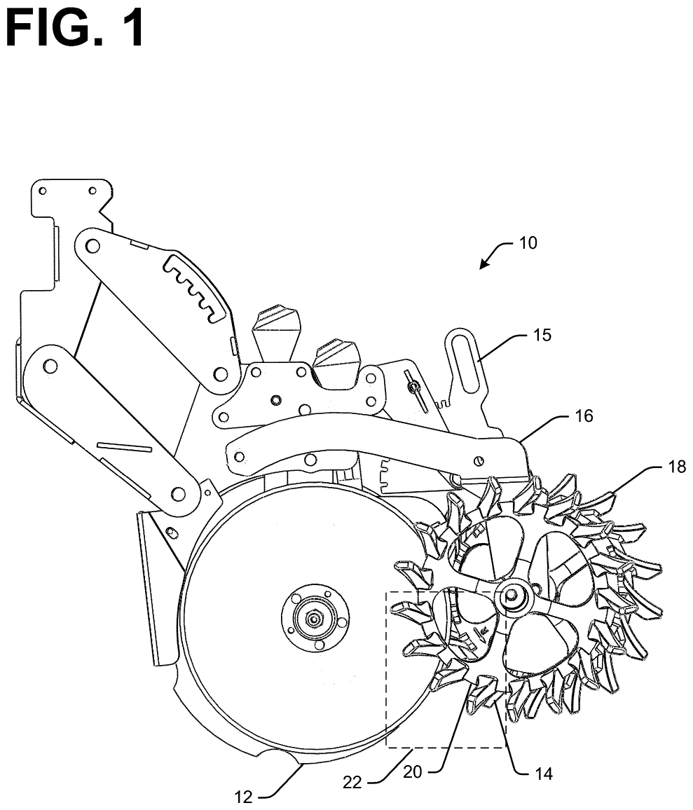

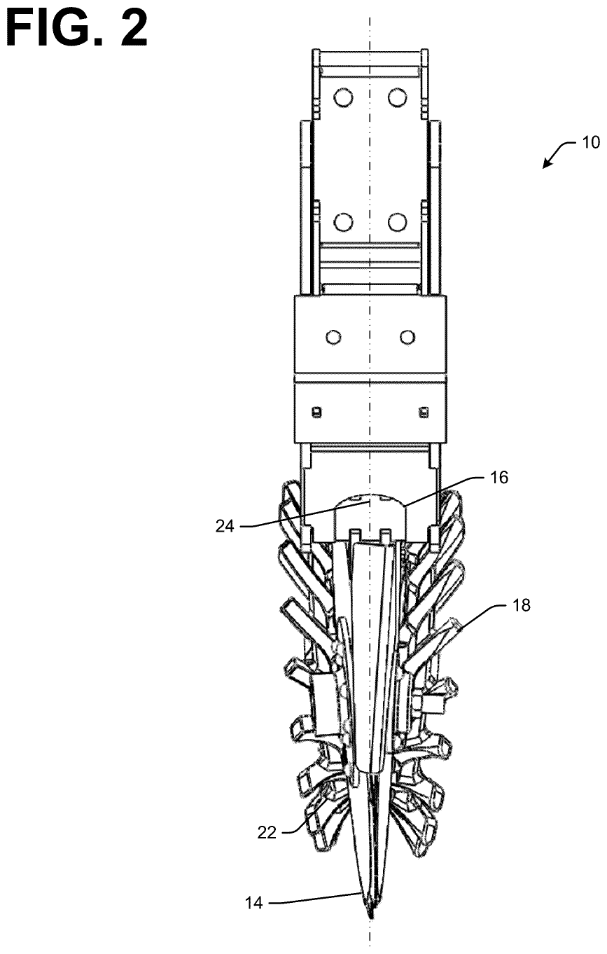

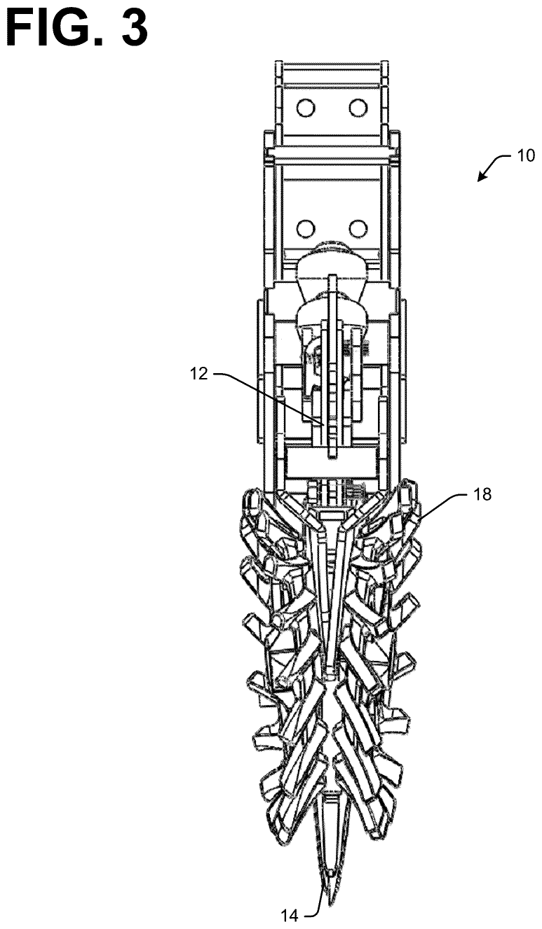

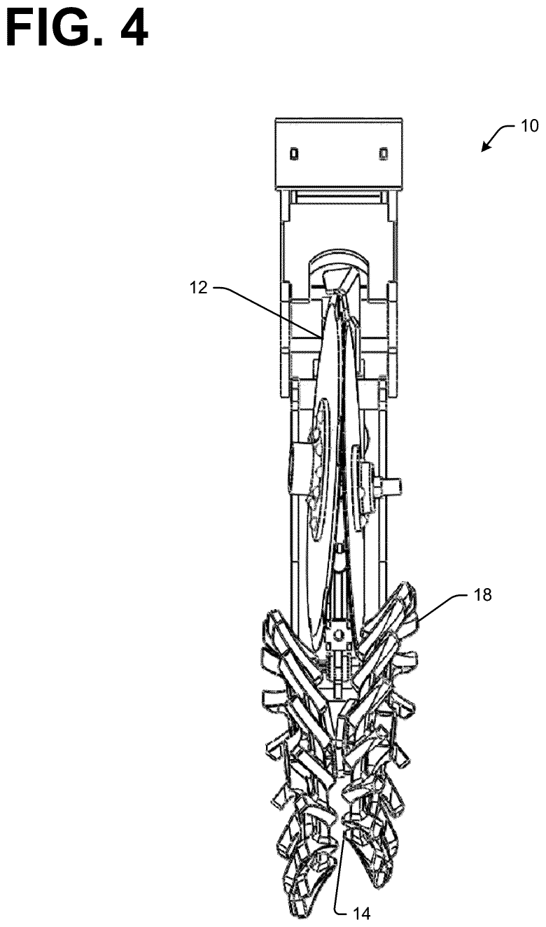

FIG. 1 depicts a side perspective view of an example multi-functional wheel trenching device 10. FIG. 2 depicts a front perspective view of the example multi-functional wheel trenching device. FIG. 3 depicts a rear perspective view of the example multi-functional wheel trenching device. FIG. 4 depicts a bottom perspective view of the example multi-functional wheel trenching device.

In an example, the device 10 may be attached to a tractor or other farm equipment, and implemented as an agricultural planter with seed trencher disc(s) 12 and multi-functional wheel(s) 14 having a seed delivery mechanism which deposits seeds and/or other product (e.g., fertilizer) in a trench opened by the disc(s) 12. The multi-functional wheel(s) 14 are mounted rearward of the trencher disc(s) 12 on an adjustable arm 16 so as to provide a depth gauging function for the trencher disc(s) 12.

In an example, the multi-functional wheel(s) 14 are mounted to run at an angle and distance corresponding to the disc blade(s) 12 so as to movably scrape clean dirt and debris from the disc blade(s) 12 opening the trench. The multi-functional wheel(s) 14 are positioned to move displaced trench soil back over the trench while effectively running at a position where dirt and debris try to lift out of the opening trench due to the action of the disc cutting blade(s) 12. This allows the multi-functional wheel(s) 14 to apply pressure in a lift out zone area of dirt and debris to prevent the lift out from occurring. This effectively provides the device 10 with a closing function, which allows the lifted debris and dirt, to enclose the trench if this function is actuated by its operator.

An example multi-functional wheel trenching device 10 includes a trench opener disc 12 and a multi-functional wheel 14 coupled to the trench opener disc 12. The multi-functional wheel 14 includes one or more gauging mechanism (e.g., movable arm 16) for the trench opener disc 12. The example device 10 also includes a trench closing mechanism and a cleaner mechanism to scrape dirt and residue from the trench opener disc 12.

The example multi-functional wheel trenching device 10 also includes an array of fingers 18, each of short length relative to a radius of the multi-functional wheel 14. Each of the array of fingers 18 extend forward of an outer rim 20 of the multi-functional wheel 14 as the multi-functional wheel 14 rolls through a lower forward quadrant 22. Each of the array of fingers 18 also extend outward of a vertical plane (see, e.g., plane 24 illustrated in FIG. 2) of the multi-functional wheel 14.

The example multi-functional wheel trenching device 10 may also include an array of teeth positioned around an outer rim or circumference of the multi-functional wheel. In an example, each of the array of teeth extend inward from the plane of the multi-functional wheel. In an example, each of the array of teeth are configured to scrape dirt from the trench opener disc. In an example, each of the array of fingers are curved and cupped.

In an example, the array of fingers 18 around the wheel rim further prevent soil lift out and aid in movement of crop debris and residue through the system while reducing the soil to a fine homogenous soil for an optimal planting condition. Each of the array of fingers 18 are positioned in a way to surround the radius of the wheel 14. Each finger of the array of fingers 18 is configured to be short in length, relative to the radius of the wheel 14, and further positioned to extend forward of the outer rim of each wheel 14. As the wheel 14 rolls forward, through a lower forward quadrant 22, each of the fingers 18 extends outward from the plane of the wheel 14. Furthermore, this multi-functional wheel configuration allows for narrow spacing of adjacent seeder devices while keeping crop debris residue from building up between devices and plugging.

In an example, the trench opener disc 12 is configured to rotate the array of fingers 18 to move soil into a trench. The multi-functional wheel(s) 14 may be configured to rotate the array of fingers 18 to move soil into a trench.

In an example, the multi-functional wheel 14 is configured to adjust in a vertical direction, resulting in a gauge of a seeder planting depth. Through adjustment of the position of a handle 15 that is pivotally connected to the disc opener body and the multifunctional wheel(s) mounting bracket, vertical height adjustment can be made to the multifunctional wheel(s) resulting in gauging of desired seeder planting depth. It is noted that the handle 15 depicted in the drawings is only an example. The handle can be any form of adjustable moving mechanisms, for example, including a screw adjustment, an actuator, a slotted adjustment, etc.

In an example, the multi-functional wheel 14 is adjustable in a horizontal direction via a horizontal chamber relative to a central plane of the multi-functional wheel, resulting in an increase or decrease of soil over a seed trench. Vertical adjustment is achieved through unlocking the handle 15 and positioning it to the desired vertical depth orientation.

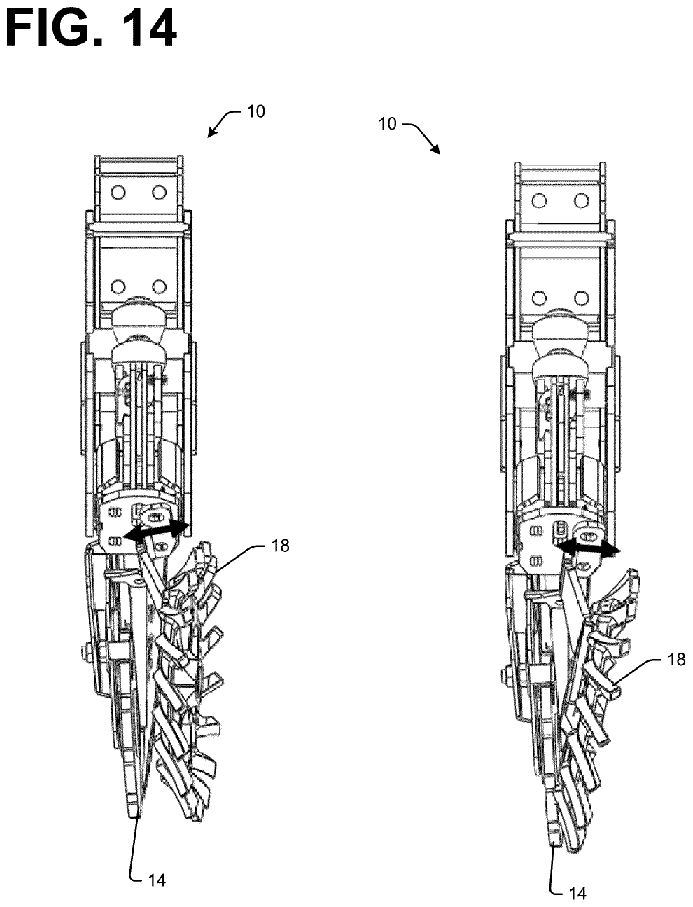

FIG. 14 shows an example of camber adjustment relative to the central plane. In an example, the adjustment can be performed by a 2 bolt hole configuration where one loosens the slotted hole and shifts the wheel configuration within the constraints of the slotted hole thereby adjusting the camber and pitch orientation of the wheel to move more or less soil over the seed trench.

In an example, the multi-functional wheel 14 is adjustable in a vertical direction and in a pitch angle relative to a central plane of the multi-functional wheel 14, resulting in an increase or decrease of a movement of soil.

In an example, the trench opener disc 12 is configured to be adjustable in pitch and camber relative to a central plane of the trench opener disc 12. This may be achieved by an angled washer that is adjusted relative to the predetermined angled plane, and then the bolt is tightened to the bearing of the trench opener disc to adjust pitch and camber.

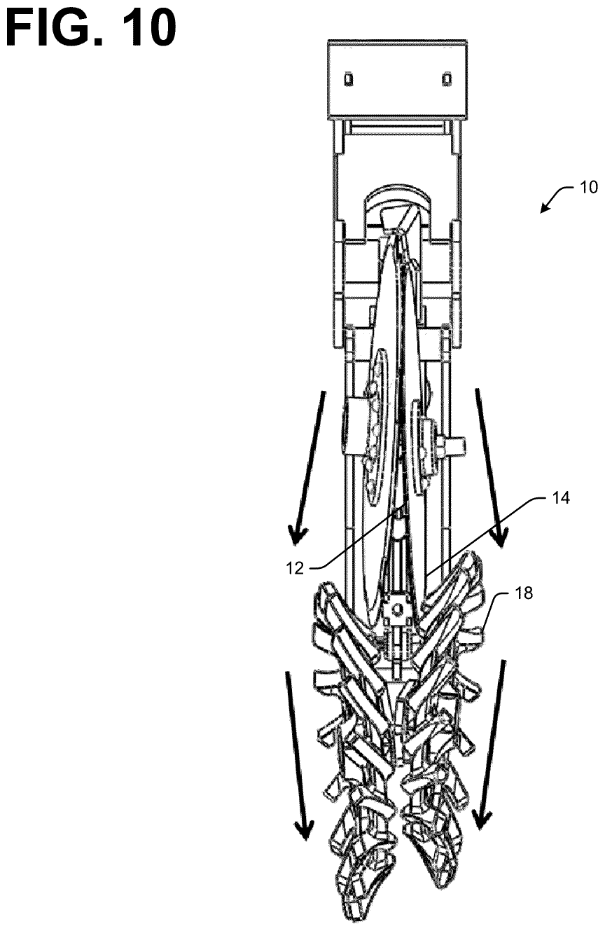

In an example, the multi-functional wheel 14 is configured with a reverse horizontal chamber and vertical pitch of the trench disc opener 12. FIG. 10 shows an approximately reverse matching configuration of camber and pitch between the trench disc openers and the multi-functional wheel(s). FIG. 14 shows how the camber adjustment to the central plane can be performed by a 2 bolt hole configuration, where one loosens the slotted hole and shifts the wheel configuration within the constraints of the slotted hole thereby adjusting the camber and pitch orientation of the wheel to move more or less soil over the seed trench.

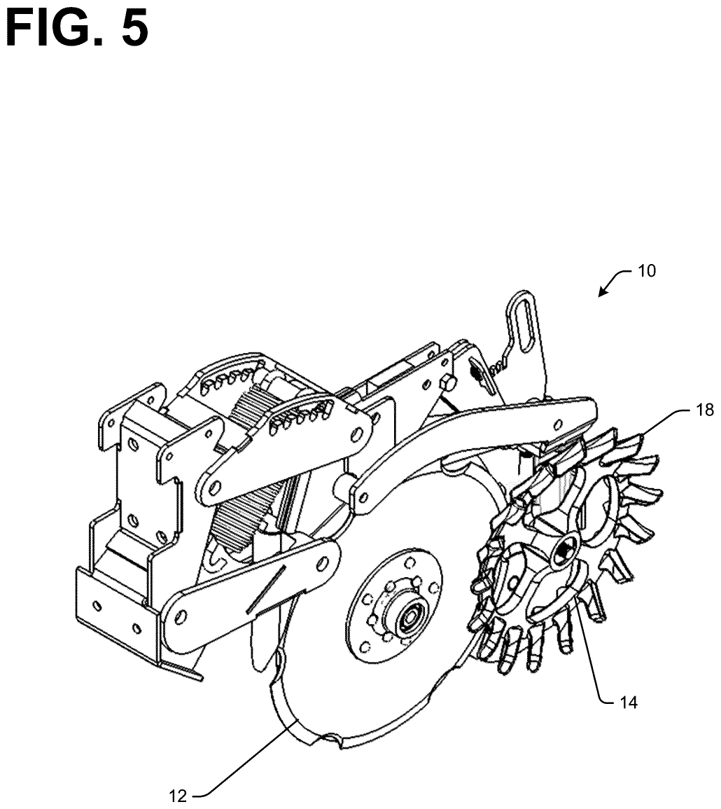

FIG. 5 depicts a perspective view of the example multi-functional wheel trenching device 10. In this example, each of the multi-functional wheels 14 are configured to include an array of teeth 18 positioned around the outer rim of the wheel 14. Each of the teeth 18 are positioned relative to the radius of the wheel 14 and extend forward of the outer rim of the wheel 14.

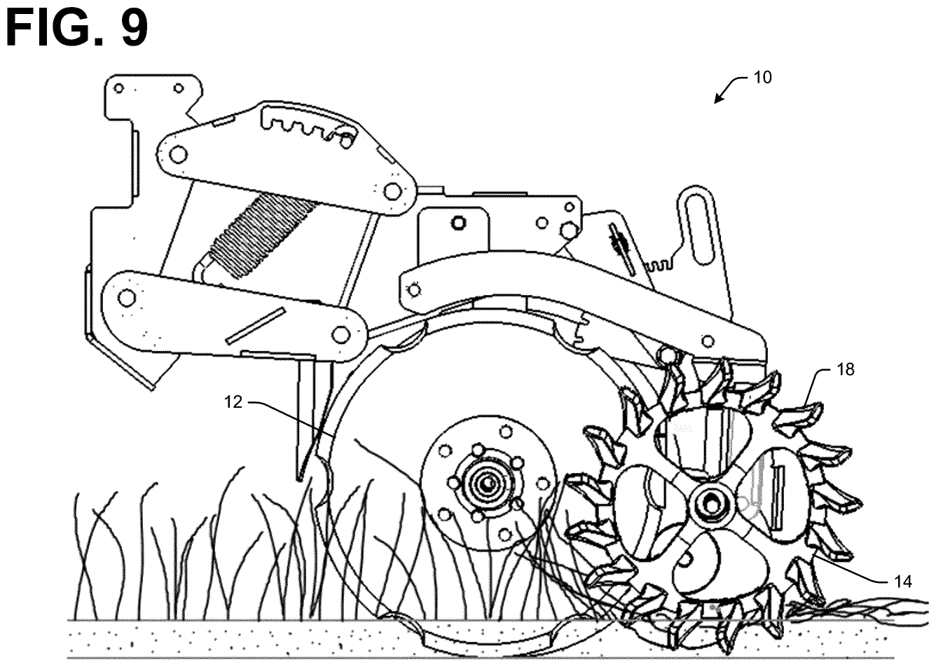

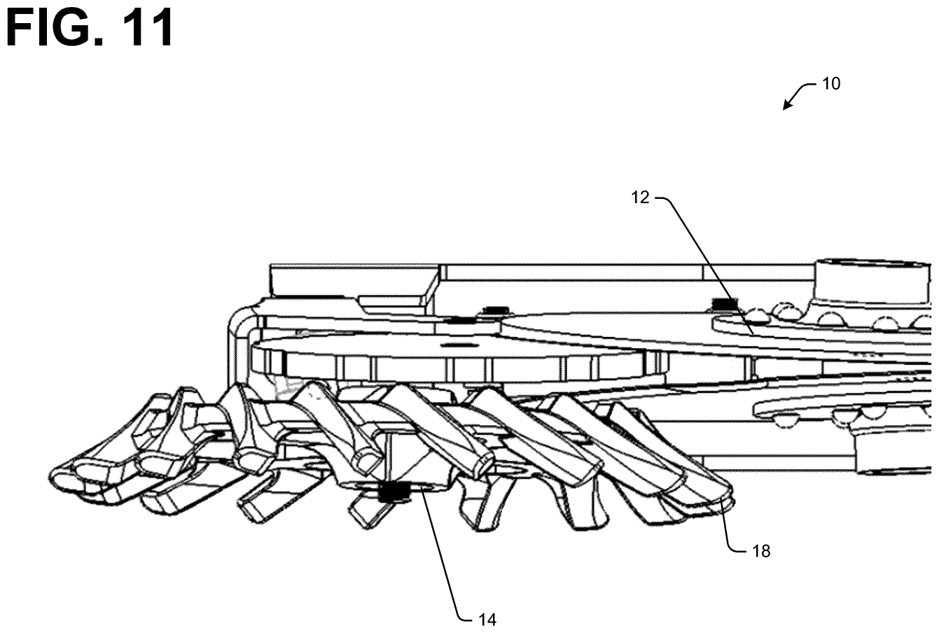

During operation, as the wheel 14 rolls forward, the teeth 18 are configured to functionally scrape dirt and residue from the trench opener disc 12. FIG. 9 shows the action of the teeth 18 of the multi-functional wheel(s) 14 moving through the soil and crop residue. The inward extension of the teeth 18 are approximately close to the trench disc opener as to functionally scrap the disc clean of any carry over soil or residue remaining on the disc as it rotates out of the ground. FIG. 11 shows the bottom view in more detail of what the inward extension of teeth 18 looks like.

The array of fingers 18 can also be configured to be curved and cupped so as to move soil into the trench that is formed by the trench opener disc 12. FIG. 11 shows this curvature of the fingers 18

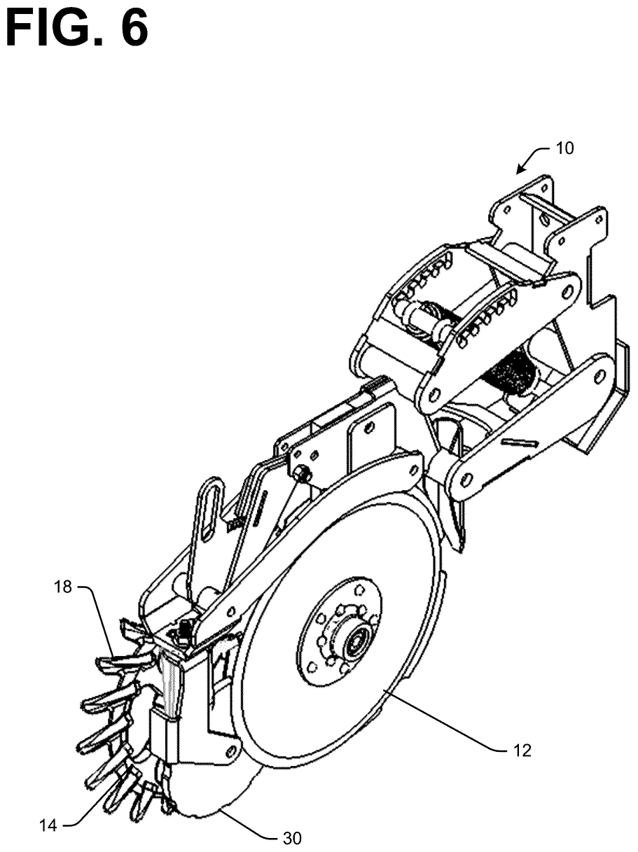

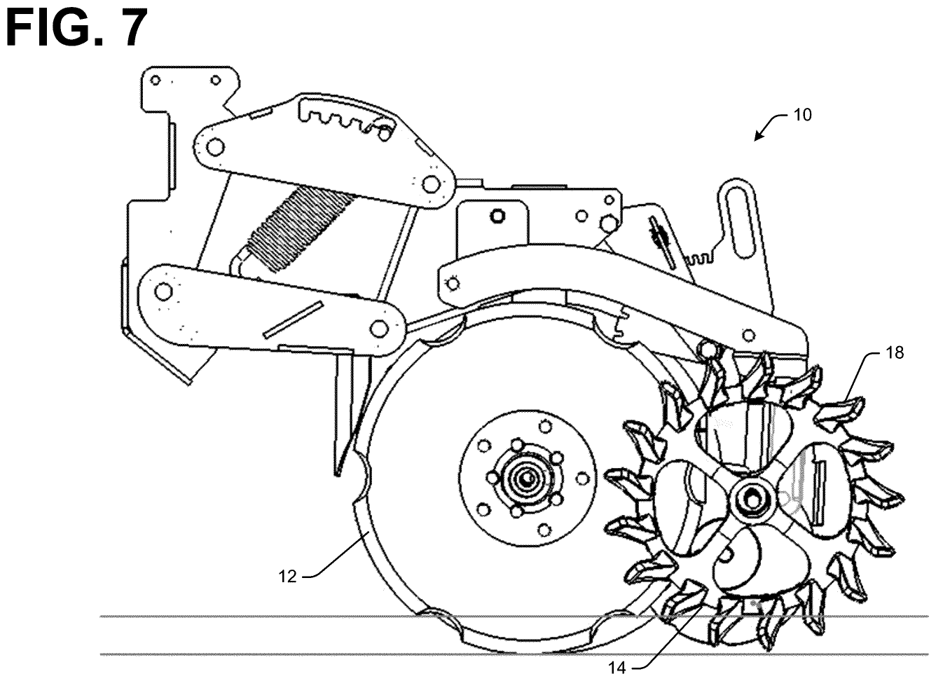

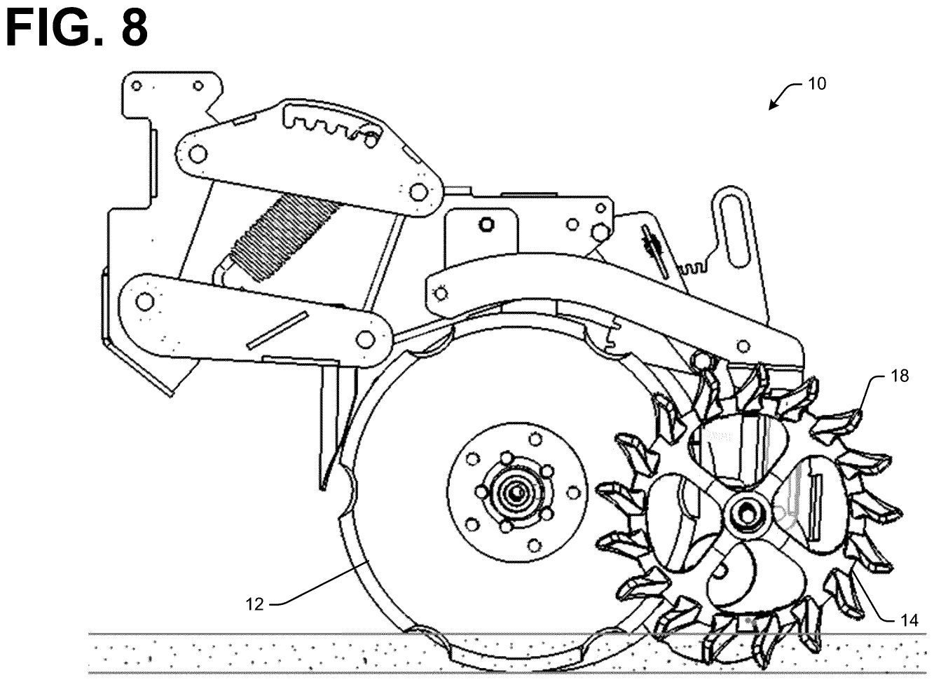

FIG. 6 depicts a perspective view of an example single multi-purpose wheel device 10 with in row firming wheel 30. FIG. 7 depicts a side perspective view of the example single multi-purpose wheel device 10 with in row firming wheel 30. FIG. 8 depicts an additional side perspective view of an example single multi-purpose wheel device 10 with in row firming wheel 30.

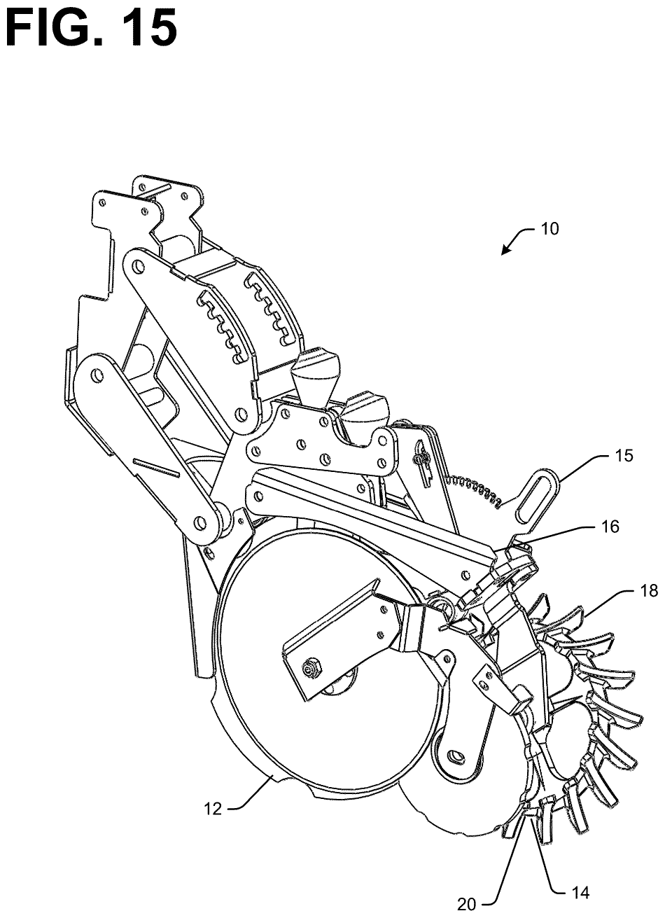

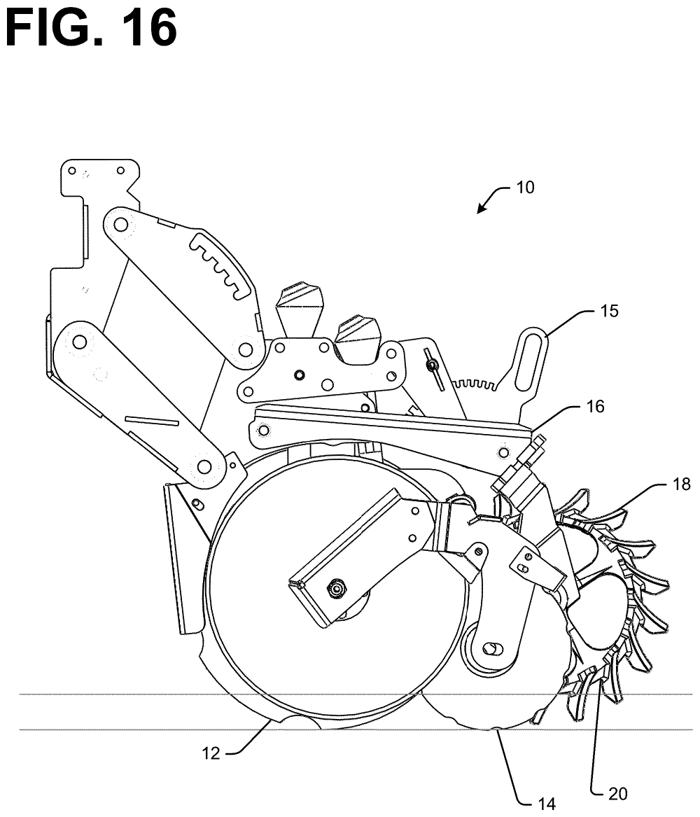

FIG. 15 and FIG. 16 illustrate an in-row firming wheel 30 that is spring/torsion loaded and runs in the bottom of the seed trench created by the trench opener disc 12, but before multipurpose wheel 10, in order to ensure that the seed is deposited in the bottom of the seed trench and firmed/pressed to the desired amount. This ensures optimal seed to soil contact, and even emergence of sprouted seed for the well-being of each plant. A firming wheel 30 may be rotatably mounted to the center of trench opener disc 12 via a spring or torsioned lever arm as to rotatably follow the concentricity of the trench opener disc 12 in its range of travel, as seen in FIG. 16.

FIG. 9 depicts a functional side perspective view of an example single multi-purpose wheel device 10. FIG. 10 depicts a bottom perspective view of the example multi-purpose wheel device 10, illustrating wheel rotations to open a trench and deposit seed

FIG. 9 shows the action of the teeth 18 of the multi-functional wheel(s) 14 moving through the soil and crop residue. FIG. 10 shows an approximately reverse matching configuration of camber and pitch between the trench disc openers and the multi-functional wheel(s). The large arrows help represent the movement soil, direction of travel as the wheels and disc turn, and further illustrates the reverse matching configuration.

FIG. 11 depicts a wheel 14 of the example multi-purpose wheel device 10 displaying curved and cupped fingers of the wheel 14. Of course, any number of wheels 14 may be provided, as it will be understood by those having ordinary skill in the art after becoming familiar with the teachings herein.

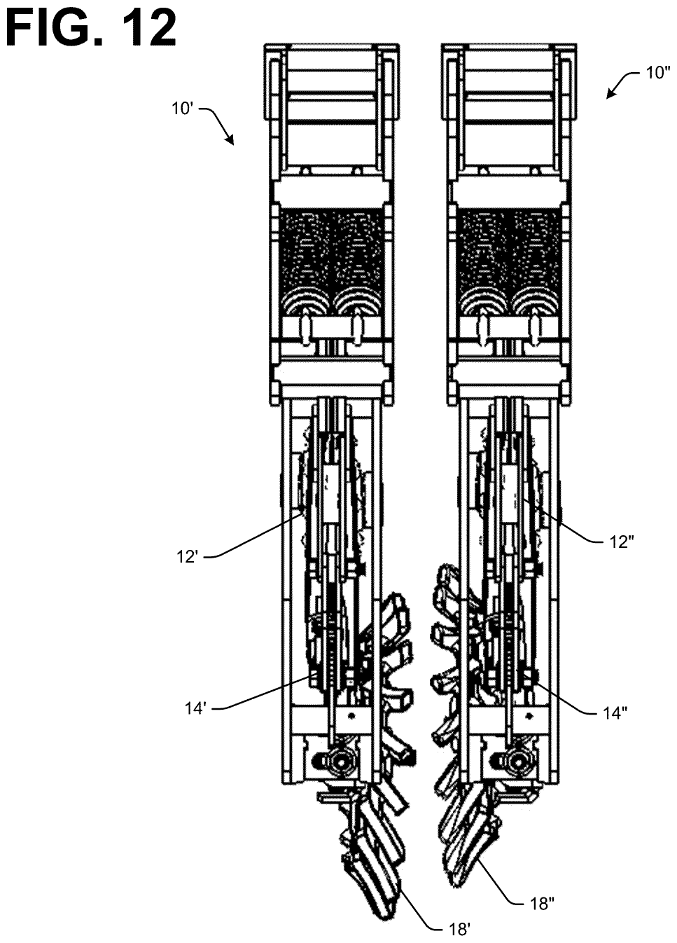

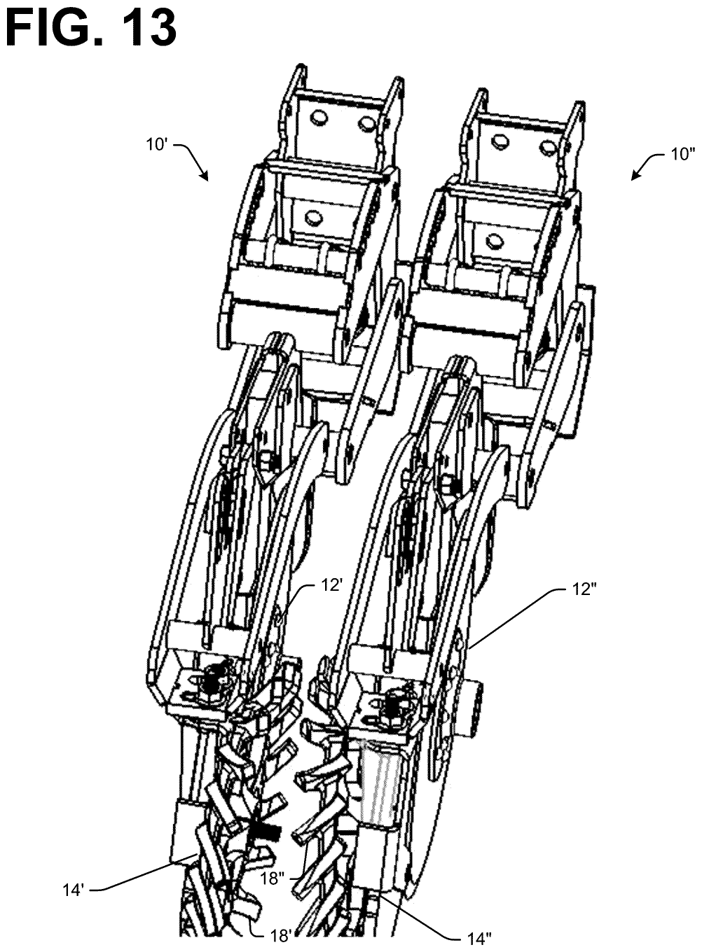

FIG. 12 depicts a top perspective view of two example single multi-purpose wheel devices 10′ and 10″ operating in tandem. FIG. 13 depicts a perspective view of two example single multi-purpose wheel devices 10′ and 10″ operating in tandem. It is noted that similar reference numbers with the prime (′) and double prime (″) designation are used to refer to like components already described above, without describing those components again here.

It is noted that the wheels 14 can be adjustable in a vertical direction. The wheels 14 are adjustable in order to provide vertical depth functionality in order to gauge the planting depth of the seeder. An operator can mechanically, or automatically adjust the gauge level based on various soil levels, hardness, softness, or elevation.

In an example, the wheels 14 can also be adjustable in a horizontal direction. This adjustment can be performed according to the camber of the central plane. FIG. 14 shows how the horizontal camber adjustment to the central plane can be performed by a 2 bolt hole configuration where one loosens the slotted hole and shifts the wheel configuration within the constraints of the slotted hole thereby adjusting the camber and pitch orientation of the wheel to move more or less soil over the seed trench. The adjustment is configured to functionally increase or decrease the amount of soil that is moved over the seed trench, when the trench closing function is in operation or activated.

In an example, the wheels 14 can be adjustable in a vertical pitch angle relative to the central plane of the wheel. This adjustment can functionally increase or decrease the amount of soil that is moved over the seed trench, when the trench closing function is in operation or activated.

Additionally, the wheel 14 can be configured with a matching reversed horizontal camber, and a vertical pitch, that is relative to the trench disc opener. FIG. 10 shows an approximately reverse matching configuration of camber and pitch between the trench disc openers and the multi-functional wheel(s).

In an example implemented in combination with any of the above examples, the fingers 18 can be configured to extend inwardly of the plane of the wheel 14. Based on this positioning, the wheel 14 is configured to move dirt continuously from the outward portion of the wheel 14, to the inward portion of the wheel 14 in order to fill the seed trench.

To make this more apparent, FIG. 10 depicts the rotational direction of each of the multi-functional wheels 14 of the device 10. In addition, the operation of the device 10 is made apparent in each of FIGS. 7-9, as the wheels 14 and blades 12 are shown contacting the ground and performing the functions of the above discussed examples.

It is noted that the examples shown and described are provided for purposes of illustration and are not intended to be limiting. Still other examples are also contemplated.

1. A multi-functional wheel trenching device comprising:
a trench opener disc;
a multi-functional wheel, coupled to the trench opener disc, wherein the multi-functional wheel comprises one or more gauging mechanism for the trench opener disc;
a trench closing mechanism; and
a cleaner mechanism to scrape dirt and residue from the trench opener disc.

2. The multi-functional wheel trenching device of claim 1, further comprising an array of fingers each of short length relative to the radius of the multi-functional wheel.

3. The multi-functional wheel trenching device of claim 2, wherein each of the array of fingers:
extend forward of an outer rim of the multi-functional wheel as the multi-functional wheel rolls through a lower forward quadrant; and
extend outward of a plane of the multi-functional wheel.

4. The multi-functional wheel trenching device of claim 3, further comprising:
an array of teeth positioned around an outer rim or circumference of the multi-functional wheel.

5. The multi-functional wheel trenching device of claim 4, wherein each of the array of teeth extend inward from the plane of the multi-functional wheel.

6. The multi-functional wheel trenching device of claim 5, wherein each of the array of teeth are configured to scrape dirt from the trench opener disc.

7. The multi-functional wheel trenching device of claim 2, wherein each of the array of fingers are curved and cupped.

8. The multi-functional wheel trenching device of claim 2, wherein the trench opener disc is configured to rotate the array of fingers to move soil into a trench.

9. The multi-functional wheel trenching device of claim 1, wherein the multi-functional wheel is configured to adjust in a vertical direction, resulting in a gauge of a seeder planting depth.

10. The multi-functional wheel trenching device of claim 1, wherein the multi-functional wheel is adjustable in a horizontal direction via a horizontal chamber relative to a central plane of the multi-functional wheel, resulting in an increase or decrease of soil over a seed trench.

11. The multi-functional wheel trenching device of claim 1, wherein the multi-functional wheel is adjustable in a vertical direction and in a pitch angle relative to a central plane of the multi-functional wheel, resulting in an increase or decrease of a movement of soil.

12. The multi-functional wheel trenching device of claim 1, wherein the trench opener disc is configured to be adjustable in pitch and camber relative to a central plane of the trench opener disc.

13. The multi-functional wheel trenching device of claim 1, wherein the multi-functional wheel is configured with a reverse horizontal chamber and vertical pitch of the trench disc opener.

14. The seed trench closing wheel of claim 1, further comprising a firming wheel rotatably mounted to a center of trench opener disc to rotatably follow a concentricity of the trench opener disc in a range of travel of the trench opener disc.

15. The seed trench closing wheel of claim 14, wherein the firming wheel is rotatably mounted to the center of trench opener disc via a spring.

16. The seed trench closing wheel of claim 14, wherein the firming wheel is rotatably mounted to the center of trench opener disc via a torsioned lever arm.

17. A seed trench closing device, comprising:
a wheel having a radius;
an outer rim of the wheel;
an array of fingers having a short length relative to the radius of the wheel, wherein the array of fingers are configured to:
extend forward from the outer rim of the wheel as the wheel rolls through a lower forward quadrant;
extend outward from a planting zone of the wheel; and
curve and cup, resulting in the array of fingers scooping and moving soil to cover a seed trench.

18. The seed trench closing wheel of claim 17, wherein each of the array of fingers is configured to extend inward of a plane of the wheel, resulting in the soil moving continuously in an outward direction of the wheel, to inwardly fill the seed trench.
